(19) United States
(12) Patent Application Publication
(10) Pub. No.: US 2007/0044750 A1
(43) Pub. Date: Mar. 1, 2007

(54) High flow air filtration system

(75) Inventors: Shahriar Nick Niakan, Anaheim Hills, CA (US); Eric Charles Bajza, Garden Grove, CA (US)

Correspondence Address: SHIMOKAJI & ASSOCIATES, P.C., 8911 Research Avenue, Irvine, CA, 92618, US

(73) Assignee: Advanced Flow Engineering, Inc., Corona, CA (US)

(21) Appl. No.: 11/213,122

(22) Filed: Aug. 26, 2005

(51) Int. Cl. F02M 35/02

(52) U.S. Cl. 123/198 E

(57) ABSTRACT

A high flow air filtration system comprises a filter within a housing, a cover removably attached to the housing, an adapter between and in flow communication with the filter and an air intake of an engine. The cover includes a diverter, a flow directing portion, and a lip. The diverter is positioned between the filter and a flow of air from the vehicle ducting. The diverter slows the velocity of the flow and alters its path. The flow directing portion is adapted to direct the flow downward towards the filter. The lip is positioned along the front edge of the cover to increase the volume of external air entering the housing.

### BACKGROUND OF THE INVENTION

The present invention generally relates to air filtration systems and, more particularly, to high flow air filtration systems for combustion engines, such as vehicle engines.

Generally, a combustion engine ignites a fuel/air mixture, producing combustion gases, and then extracts energy from these gases. The air provided to the engine is usually filtered to remove dust particles and other environmental contaminants that can damage engine components.

Air filtering systems have included flattened, cylindrical and conical shaped filter elements in flow communication with the air intake of the engine. The filter elements have comprised paper filters, oil bath types, treated filament filters, mesh types, foams and others. Although these filtering systems can reduce the contaminants in the air, some filter elements may restrict the air flow into the engine, reducing engine output.

Engine output may be a function of the volume of air supplied to the engine. Filtering systems have been designed to provide increased air flow to the engine. These systems have included filter elements having improved shape and/or composition. Air flow and engine output have been increased using these systems, but further increases in engine output may be desired for some applications.

Systems that increase the supply of oxygen available for combustion have improved engine output. Because cold air may be denser than hot air, systems that reduce the temperature of the air flow through the filtering system have provided increased oxygen to the engine. Methods for reducing air flow temperature have included shielding the filter element from the heat produced by the engine and relocating the filter element away from the engine.

Systems that reduce the temperature of the airflow by shielding the filter element have positioned a heat shield between the engine and the filter element. Although filtering systems using these heat shields may provide cooler air, the heat shields reduce the volume of airflow to the engine by restricting the flow into the filter element. Additionally, for some applications, further reductions in airflow temperature are still desired.

Most OEM designs, such as a prior art closed box system 20 depicted in FIG. 1, have positioned a filter (not shown) within an enclosure 21 to provide a greater reduction in airflow temperature. For these designs, airflow enters the enclosure 21 through an inlet duct 22, passes through the filter, and exits the enclosure 21 through an outlet duct 23. Although these filtration systems may provide a reduction in airflow temperature, the path the incoming air must take in order to get to the engine can be rather restrictive. In addition, the available filter surface area is limited due to physical geometry of the OEM system. Likewise, the filter media utilized, while performing its' intended function well, also is very restrictive to air flow. Typical intake systems (not shown) that replace the restrictive closed air box arrangement may not have provisions for isolating the filter from high under hood temperatures. Others may utilize additional ducting to relocate the filter outside of the engine compartment, however the additional ducting adds restriction to incoming air. Most of these systems do not have provisions for diverting the incoming air from direct contact with the filter, which in some instances has led to engine stalling.

As can be seen, there is a need for improved air filtration systems. Air filtration systems are needed that can reduce airflow temperatures without contributing to engine stalls. Further, air filtration systems are needed wherein airflow temperatures are reduced and airflow volume to the engine is increased. Additionally, there is a need for filtration systems that more evenly distribute the airflow across the surface of the filter.

### SUMMARY OF THE INVENTION

In one aspect of the present invention, a system for an engine comprises a housing having a filter cavity; a filter element positioned within the filter cavity; a cover member removably attached to the housing; and a diverter member positioned between the filter element and an air inlet duct of the engine.

In another aspect of the present invention, a system for an engine comprises a housing; an inverted-top cone filter positioned within the housing; an adapter clamped to a back end of the inverted-top cone filter; and a cover assembly removably attached to the housing.

In still another aspect of the present invention, a system for a vehicle comprises a housing bolted to a chassis of the vehicle; a filter element positioned within a filter cavity of the housing; an adapter clamped to the filter element; a cover member in contact with the housing, the cover member having an upwardly bent edge; and a diverter member extending from the cover member and into the filter cavity.

In another aspect of the present invention, an assembly for a filtration system comprises a housing; a cover member removably attached to the housing; and a diverter member extending downward from the cover member.

In yet another aspect of the present invention, a system for a vehicle comprises a powder-coated steel housing bolted to a chassis of the vehicle; an inverted-top cone filter positioned within a filter cavity of the powder-coated steel housing; an aluminum adapter having an inlet opening at an upstream end and an outlet opening towards a downstream end, the aluminum adapter including a flow path extending from the inlet opening to the outlet opening, the aluminum adapter clamped to the inverted-top cone filter, the aluminum adapter including at least one angle such that an inner diameter towards the upstream end is greater than an inner diameter towards the downstream end; a mass airflow sensor pad operationally connected to the aluminum adapter; a cover member removably attached to the powder-coated steel housing, the cover member having an upwarding extending lip and a flow directing portion; and a diverter member connected to the cover member, the diverter member extending downward into the filter cavity, the diverter member positioned between the inverted-top cone filter and a duct of the vehicle.

In a further aspect of the present invention, a method of providing a supply of filtered air to a vehicle engine comprises the steps of passing a supply of airflow from an air inlet duct of the vehicle and into a housing; directing the airflow downward towards a filter element within the housing; reducing the velocity of the airflow; and passing the airflow through the filter element to produce the supply of filtered air.

These and other features, aspects and advantages of the present invention will become better understood with reference to the following drawings, description and claims.

### BRIEF DESCRIPTION OF THE DRAWINGS

FIG. 1 is a perspective view of a prior art closed box (OEM) system installation;

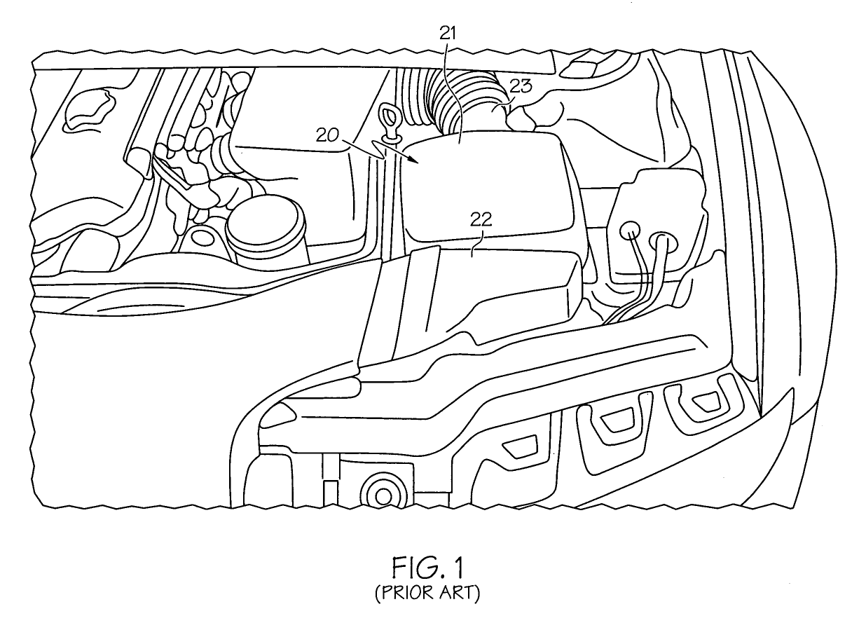

FIG. 2a is an isometric view of a high flow air filtration system with the cover in an open position according to an embodiment of the present invention;

FIG. 2b is a partially cut away view of FIG. 2a;

FIG. 3 is a perspective view of a high flow air filtration system installation according to an embodiment of the present invention;

FIG. 4a is an isometric view of a high flow air filtration system with the cover in a closed position according to an embodiment of the present invention;

FIG. 4b is a rotated view of FIG. 4a;

FIG. 5 is an isometric view of a housing according to an embodiment of the present invention;

FIG. 6 is an isometric, partial cut-away view of an adapter according to an embodiment of the present invention;

FIG. 7 is an isometric view of a cover assembly according to an embodiment of the present invention;

FIG. 8 is a view along line 8-8 of FIG. 7;

FIG. 9 is a view along line 9-9 of FIG. 7;

FIG. 10 is an isometric view of a cover member according to an embodiment of the present invention;

FIG. 11 is plan view of a cover member according to an embodiment of the present invention;

FIG. 12 is a view along line 12-12 of FIG. 11;

FIG. 13 is an isometric view of a diverter according to an embodiment of the present invention;

FIG. 14 is a view along line 14-14 of FIG. 13;

FIG. 15 is a view along line 15-15 of FIG. 13; and

FIG. 16 is a flow chart of a method of providing a supply of filtered air to a vehicle engine according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides high flow air filtration systems and methods for producing high flow filtered air for vehicles. Embodiments of the present invention may find beneficial use in many industries including automotive, aerospace, and electricity generation. Embodiments of the present invention may be beneficial in applications including automobiles, aircraft and ships. Embodiments of this invention may be useful in any air filtration application.

In one embodiment, the present invention provides a high flow air filtration system for a vehicle engine. The high flow air filtration system may comprise a filter element within a housing, a cover in contact with the housing, and an adapter positioned between and in flow communication with the filter element and an air intake of an engine.

Unlike the prior art, the cover may include a diverter that extends downward from the cover. The diverter may be positioned between the filter element and a flow of air from the vehicle ducting. As the airflow passes from the ducting to the filter element, it may contact the diverter. Contact with the diverter may reduce the velocity of the airflow and may alter the path of the airflow. The diverter may prevent the airflow from contacting the filter “straight on”. By reducing the velocity and altering the path of the airflow, the present invention may reduce potential engine stalls caused by a rush of air into the engine.

Additionally, unlike the prior art flat covers, the cover of the present invention may include a flow directing portion. The flow directing portion may be a shaped area of the cover that directs the flow from the ducting downward towards and around the filter element. The flow directing portion may improve the distribution of airflow around the circumference of the filter element and may improve filter performance.

Further, unlike the prior art, the cover may include a lip along the front edge of the cover. The lip may extend upward and may increase the volume of air entering the housing (and the filter element) from the area at the front end of the vehicle. Some prior art cover/housing assemblies (closed box designs) are adapted to allow air to enter the housing only from the ducting. By allowing air to enter the housing from both the ducting and the area under the lip, the present invention may increase the volume of air entering the filter. The increased volume of air may increase engine performance.

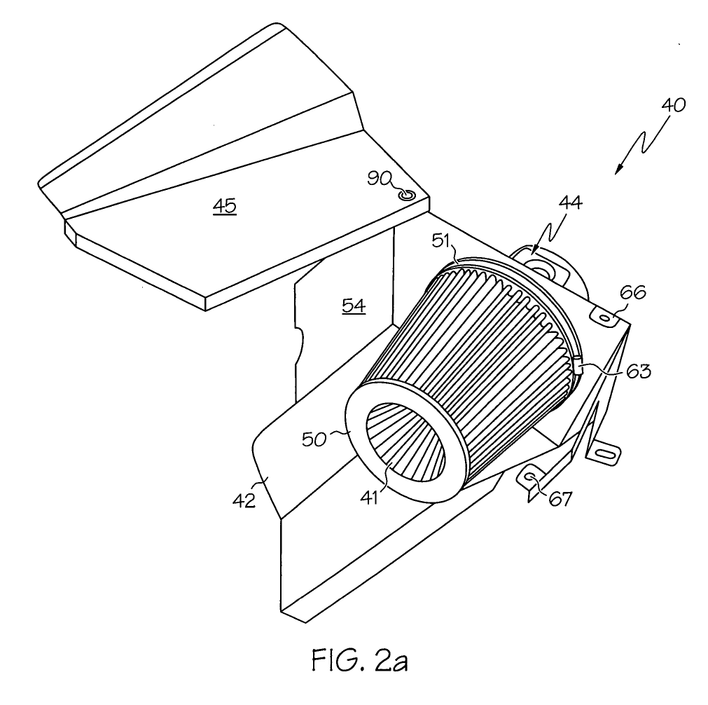

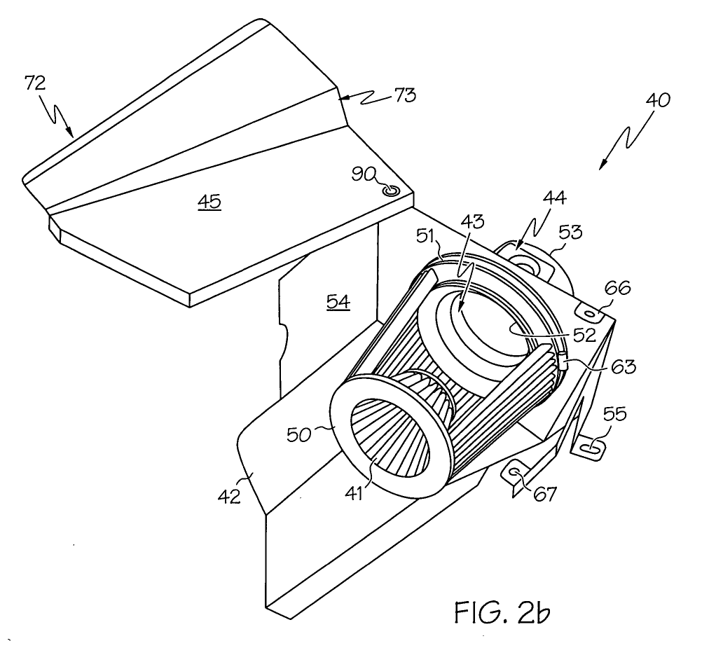

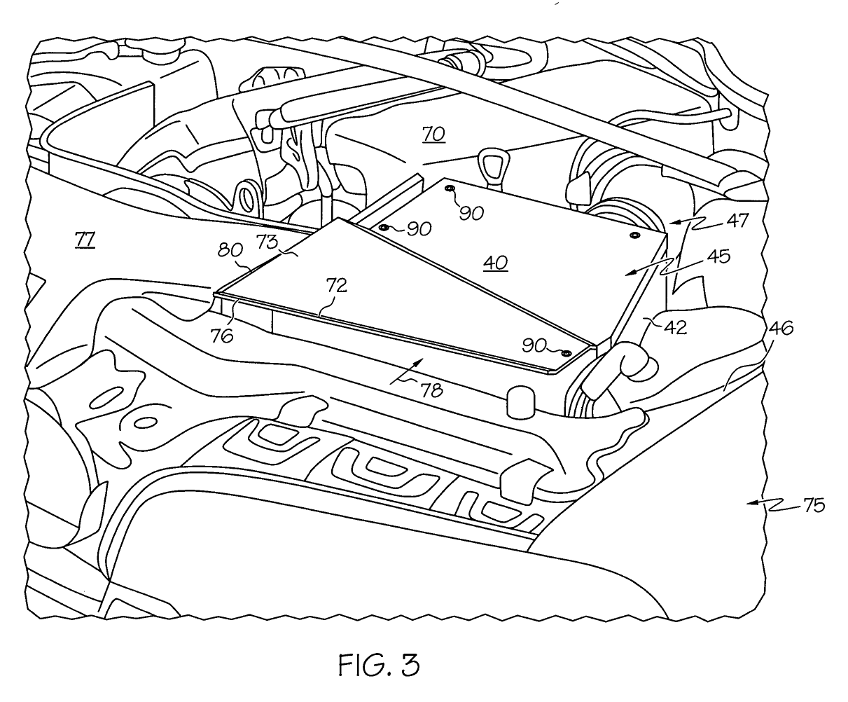

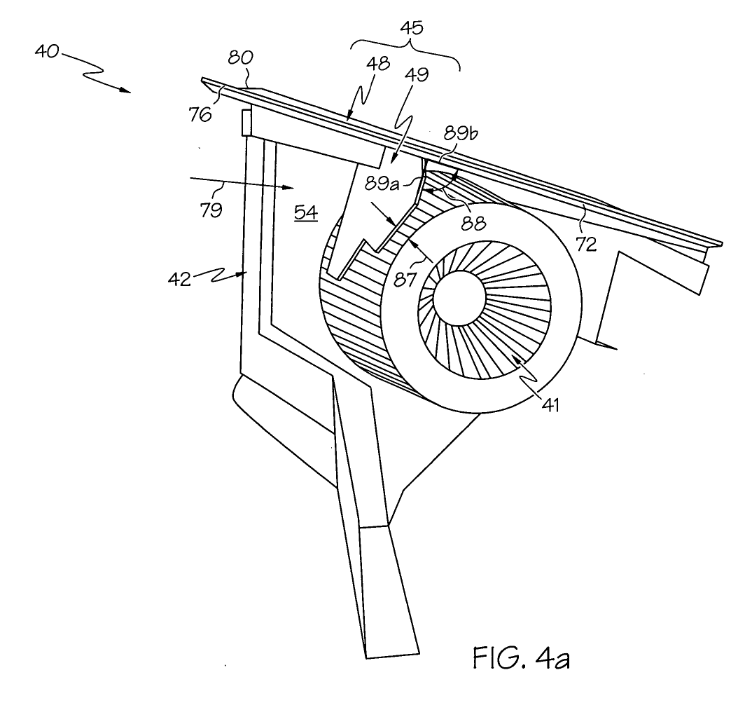

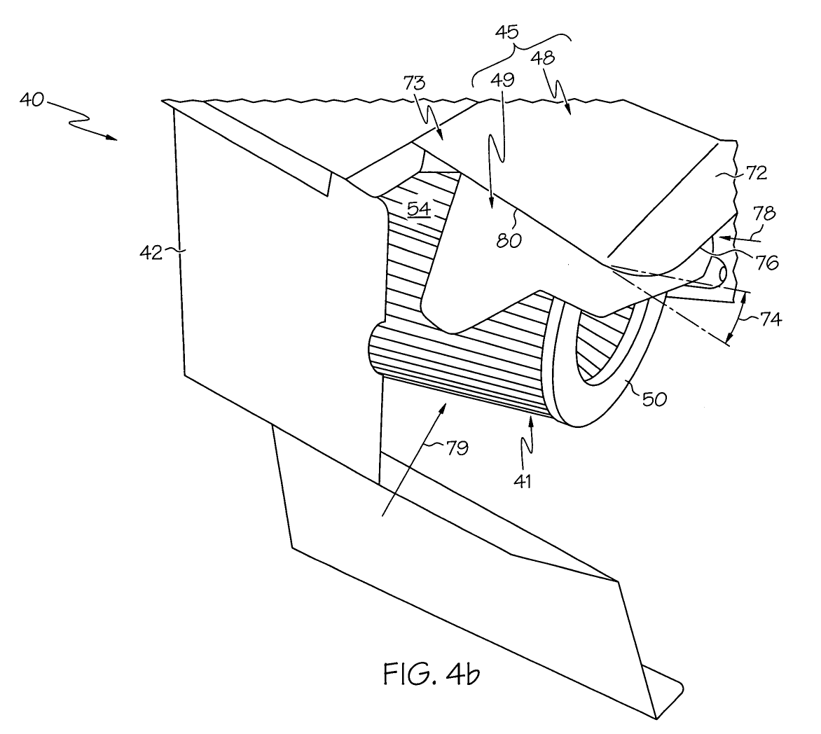

A high flow air filtration system 40 according to an embodiment of the present invention is shown in FIGS. 2a and 2b. The system 40 may comprise a filter element 41, a housing 42, an adapter 43, a mass airflow sensor pad 44 and a cover assembly 45. The filter element 41 may be positioned within the housing 42, which may be bolted to a vehicle chassis 46 (see FIG. 3). The adapter 43 may be positioned between and in contact with the filter element 41 and an engine intake, such as a plenum box tube 47 (see FIG. 3). The mass airflow sensor pad 44 may be connected to the adapter 43. The cover assembly 45 may be removably attached to the housing 42 and may comprise a cover member 48 and a diverter member 49, as depicted in FIGS. 4a and 4b.

The filter element 41, as depicted in FIG. 2a, may comprise any known filter element. The filter element 41 may comprise an inverted-top cone filter, as depicted. The filter element 41 may comprise materials, such as fibers and foams. The filter element 41 may comprise any known filter material, such as natural and synthetic fiber media. For some applications, the filter element 41 may comprise cotton and polyester pleated filter material. The filter element 41 may be washable and reusable. The filter element 41 may have a front end 50 and a back end 51, as depicted in FIG. 2b. The back end 51 may be adapted to couple with an upstream end 52 of the adapter 43. The upstream end 52 and a downstream end 53 may be defined with reference to the direction of air flow through the adapter 43. The filter element 41 may be positioned within a filter cavity 54 of the housing 42, as depicted in FIG. 2b.

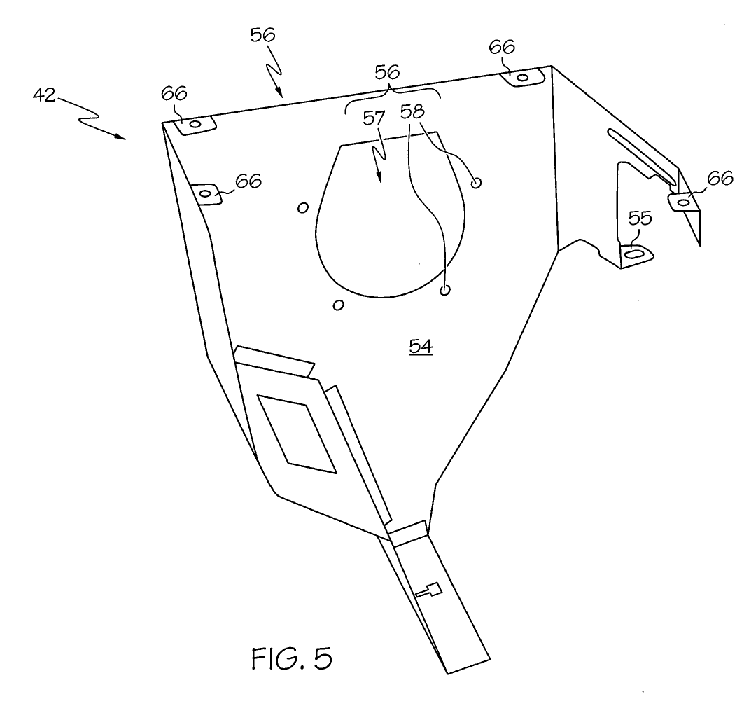

An embodiment of the housing 42 is depicted in FIG. 5. The housing 42 may comprise a structure adapted to provide the filter cavity 54 and to shield the filter element 41. The housing 42 may be positioned such that it may shield the filter element 41 from the heat produced by an engine 70 (see FIG. 3). The housing 42 may comprise various materials including powder-coated steel, aluminum, plastic, and others. Any heat shielding material may be useful with the present invention. The shape and dimensions of the housing 42 may vary and may depend on factors including the dimensions of the filter element 41 and the application.

The housing 42 may comprise at least one bolt hole 55, as depicted in FIG. 5. The bolt hole 55 may be useful during the installation of the high flow air filtration system 40. The housing 42 may be attached to the vehicle chassis 46 by at least one bolt (not shown). For some applications, other attaching apparatus such as rivets (not shown), clamps (not shown), screws (not shown) and nuts (not shown) may be used in lieu of the bolts.

The housing 42 may include at least one internal lid coupler 66, as depicted in FIG. 5. The lid coupler 66 may be useful for removably attaching the cover assembly 45 to the housing 42. The lid coupler 66 may comprise a tab-shaped structure having an opening for receiving a fastener, such as a PEM® nut 67 (see FIG. 2b). The PEM® nut 67, a self-clinching fastener known in the art, may be available from Penn Engineering & Manufacturing Corp. The PEM® nut 67 may provide a neat appearance due to the fact it can be mounted directly to the lid coupler 66. Fasteners 90 used to attach the cover assembly 45 to the housing 42 may not require access to the filter cavity 54. For some applications, other attaching apparatus such as rivets (not shown), clamps (not shown), screws (not shown) and nuts (not shown) may be used in lieu of the PEM® nuts 67, but the lid coupler 66 may have to be external.

The housing 42 may include an adapter coupling portion 56, as depicted in FIG. 5. The adapter coupling portion 56 may comprise an opening 57 through which at least a portion of the adapter 43 may be passed such that the upstream end 52 of the adapter 43 is positioned within the filter cavity 54. The adapter coupling portion 56 may include at least one coupling hole 58 for bolting the housing 42 to the adapter 43.

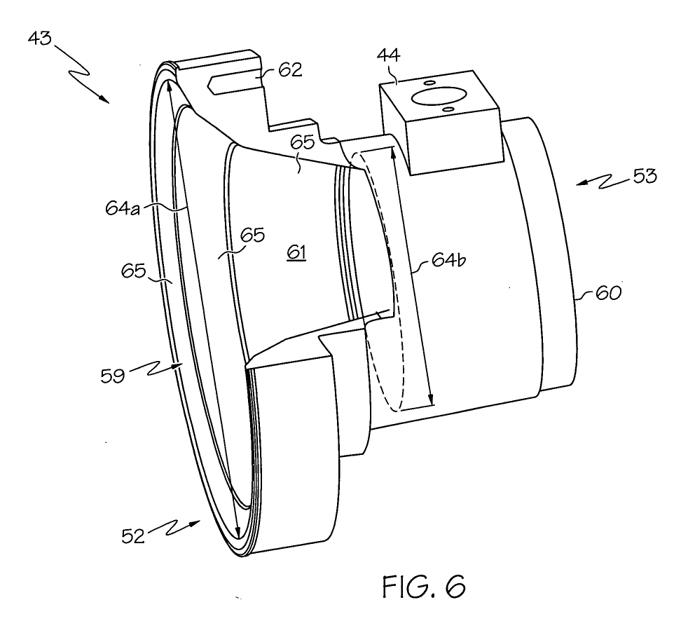

An embodiment of the adapter 43 is depicted in FIG. 6. The adapter 43 may comprise a structure having an inlet opening 59 at the upstream end 52 and an outlet opening 60 at the downstream end 53. The adapter 43 may comprise a flow path 61 extending from the inlet opening 59 to the outlet opening 60. The flow path 61 may comprise a passage positioned between and in flow communication with the filter element 41 and the plenum box tube 47. The adapter 43 may comprise aluminum. For some applications, the adapter 43 may comprise other metals, such as steel and brass, or a plastic.

The adapter 43 may have at least one bolt cavity 62 for bolting the adapter 43 to the housing 42. In other words, the adapter 43 may be connected to the housing 42 by lining up the bolt cavities 62 with the coupling holes 58 of the adapter coupling portion 56 and bolting the two components together.

The upstream end 52 of the adapter 43 may be designed to couple with the back end 51 of the filter element 41. The upstream end 52 of the adapter 43 may be connected to the back end 51 of the filter element 41 by a clamp 63 (see FIG. 2b). For some applications, other attaching apparatus such as rivets (not shown), bolts (not shown), screws (not shown) and nuts (not shown) may be used in lieu of the clamp 63. The adapter 43 may be designed such that an inner diameter 64a towards the upstream end 52 is greater than an inner diameter 64b towards the downstream end 53, as depicted in FIG. 6.

The adapter 43 may include at least one angle 65 for reducing the inner diameter of the adapter 43. The number of angles 65 may vary and may depend on the inner diameter 64a towards the upstream end 52 and the inner diameter 64b towards the downstream end 53. For example, when the inner diameter 64a towards the upstream end 52 is about 5-½ inches and the inner diameter 64b towards the downstream end 53 is about 3 inches, the adapter 43 may have three angles 65. The angles 65 may be positioned between the inlet opening 59 and the outlet opening 60 and may be adapted to reduce turbulence resulting from the difference in area between the inlet opening 59 and the outlet opening 60. The angles 65 may reduce turbulence within the flow path 61 to provide an aerodynamic flow path for the filtered air (not shown). Alternatively, the adapter 43 may have a radiused entry (not shown) in lieu of the angles 65 to provide the inner diameter reduction and aerodynamic flow path.

The down stream end 53 of the adapter 43 may be coupled to a component of the engine 70. For some applications the downstream end 53 may be coupled to an intake manifold (not shown) or an intake portion of a carburetor/throttle body (not shown) using a connecting assembly (not shown). The connecting assembly may comprise any coupling apparatus, such as a length of flexible tubing and a pair of hose clamps. For some applications, such as for a 2001 and up BMW M3 application, the downstream end 53 may be coupled to the plenum box tube 47 (see FIG. 3).

The adapter 43 may include provisions to retain the vehicle's mass airflow sensor (MAF) (not shown). The mass airflow sensor pad 44 (MAF pad), as depicted in FIG. 6, may be operationally connected to the adapter 43 and may provide a mounting surface for the MAF. MAFs may be known in the art and may be used by the engine control unit (ECU) (not shown) to determine the amount of air entering the engine 70. The ECU may use the input from various sensors on the engine 70 to determine optimum spark advance and fuel delivery for the engine 70. For some applications, the MAF pad 44 may be welded to the adapter 43. For some applications, the adapter 43 and MAF pad 44 may be a one-piece construction.

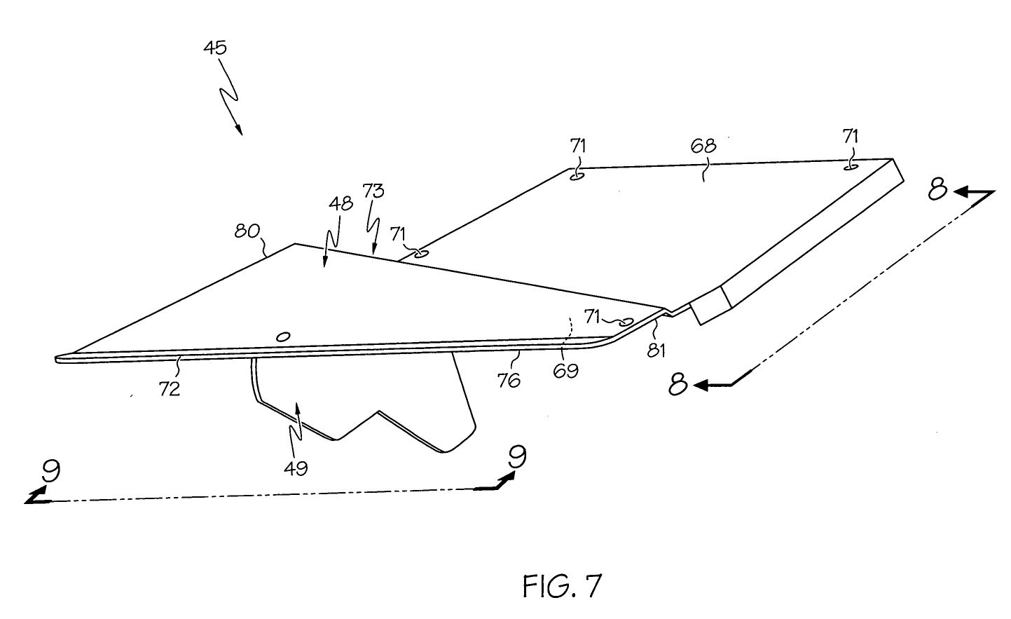

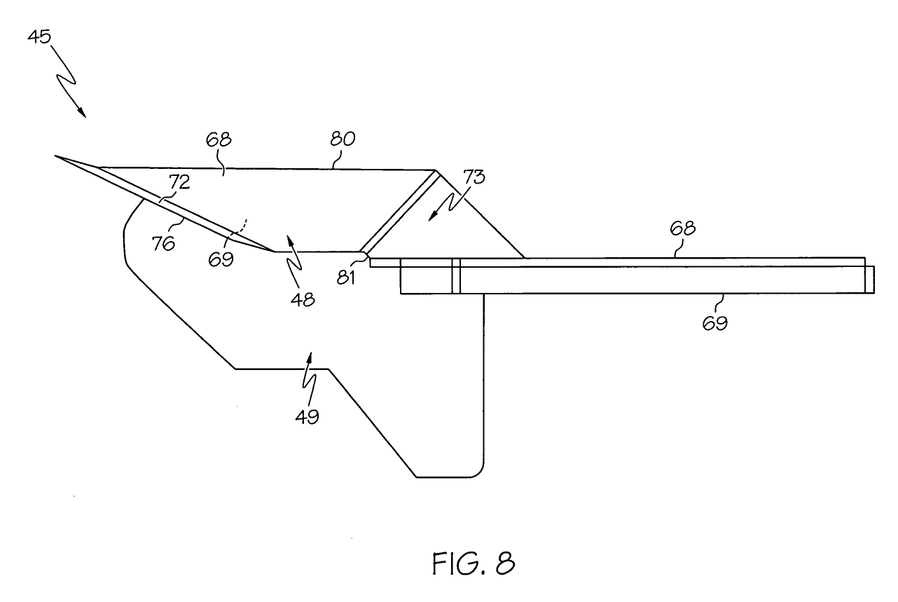

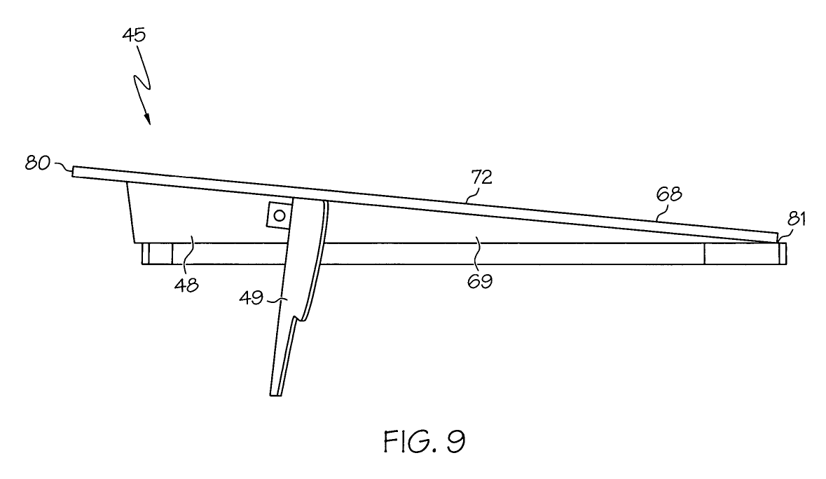

An embodiment of the cover assembly 45 is depicted in FIGS. 7-9. The cover assembly 45 may be removably attached to the housing 42, as depicted in FIG. 2b. The cover assembly 45 may comprise various materials including powder-coated steel, aluminum, plastic, and others. The shape and dimensions of the cover assembly 45 may vary and may depend on factors including the dimensions of the filter element 41, the dimensions of the housing 42, the dimensions of a duct 77 of a vehicle 75 (see FIG. 3) and the application. The cover assembly 45 may comprise the cover member 48 and the diverter member 49, as depicted in FIGS. 7-9.

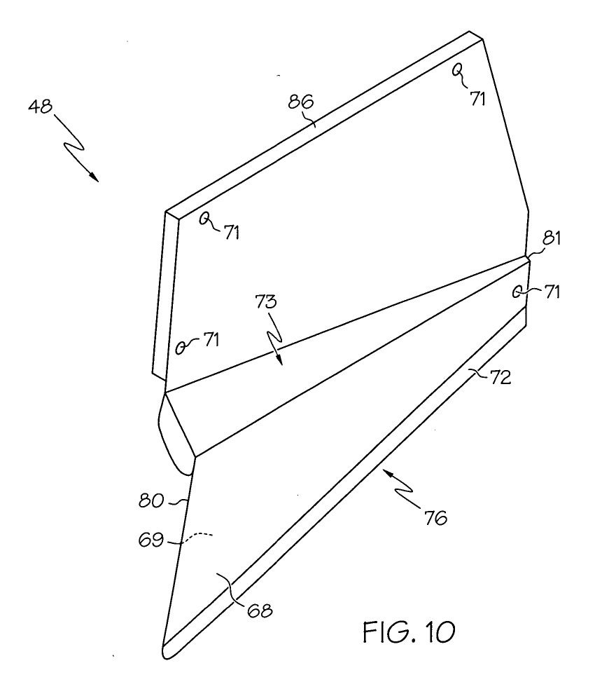

The cover member 48, as depicted in FIGS. 10-12, may comprise a structure having a top side 68, a bottom side 69, a first edge 76, a second edge 80, a third edge 81, and a fourth edge 86. The top side 68 may be the surface facing away from the filter element 41 and the bottom side 69 may be the surface facing towards the filter element 41. The first edge 76 may be the edge towards the front end 50 and the fourth edge 86 may be the edge towards the back end 51. The second edge 80 may be the edge towards the duct 77 and the third edge 81 may be the edge away from the duct 77.

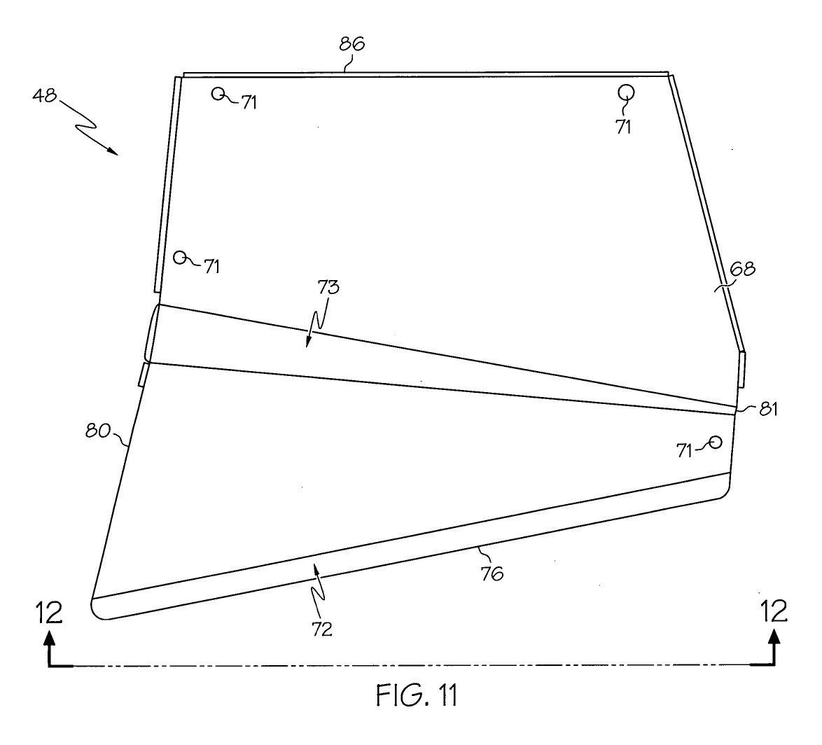

The cover member 48, as depicted in FIGS. 10-12, may include a lip 72 and a flow directing portion 73. The lip 72 may be a portion of the cover member 48 along the first edge 76. During operation, the lip 72 may be positioned towards the front end 50 of the filter element 41. The flow directing portion 73 may be a portion of the cover member 48 that extends from the second edge 80 to the third edge 81 (see FIG. 10). During operation, the flow directing portion 73 may be positioned over the filter element 41, as depicted in FIG. 4b. The cover member 48, as depicted in FIG. 11, also may include at least one fastener opening 71. The fastener opening 71 may be useful for removably attaching the cover member 48 to the housing 42 and may be designed to receive the fastener 90.

The lip 72 may comprise a portion of the cover member 48. The lip 72 may be an edge portion of the cover member 48 that has been bent upward and away from the filter element 41. Upward and downward may be defined with reference to the high flow air filtration system 40 installation. The lip 72 and the adjacent area of the cover member 48 may form a lip angle 74, as depicted in FIG. 4b. For some applications, the lip angle 74 may be between about 5° and about 45°. The lip angle 74 may vary with application. For example, the lip angle 74 may be about 13° for a BMW M3 application. The lip 72 may be adapted to increase the airflow to the filter element 41. As depicted in FIGS. 3 and 4b, a supply of external air 78 that is flowing towards the front end of the high flow air filtration system 40 may be directed by the lip 72 to enter the filter cavity 54 of the housing 42. In other word, the external air 78 may contact the lip 72 that directs the external air 78 downward and into the housing 42. For some applications, the lip 72 may increase the volume of air that enters the filter cavity 54 from the front end of the vehicle 75 (see FIG. 3).

The flow directing portion 73 may be an area of the cover member 48 adjacent to the lip 72 and may extend across the cover member 48 from the second edge 80 to the third edge 81. The flow directing portion 73 along the second edge 80 may be designed to follow the profile of the duct 77, as depicted in FIG. 3. The flow directing portion 73 along the third edge 81 may be designed to contact the housing 42.

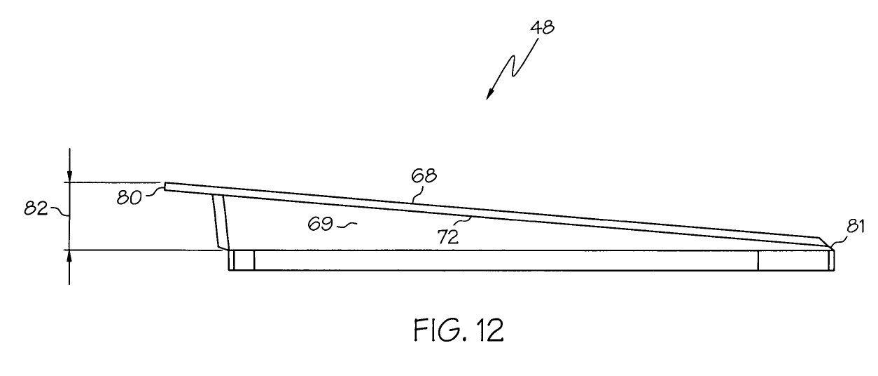

When installed, the area of the flow directing portion 73 towards the second edge 80 and the area of the flow directing portion 73 towards the third edge 81 may be positioned at different heights relative to one another. In other words, there may be a height difference 82 between the second edge 80 and the third edge 81, as depicted in FIG. 12. The height difference 82 between the second edge 80 and the third edge 81 may vary with application, which may be determined by under hood geometry.

The flow directing portion 73 along the second edge 80 may be adapted such that a supply of duct airflow 79 may pass from the duct 77 and enter the filter cavity 54, as depicted in FIG. 4b. The flow directing portion 73 may be adapted to direct the duct airflow 79 downward and around the filter element 41. The flow directing portion 73 may be designed to more evenly distribute the duct airflow 79 around the filter element 41. The more even distribution of duct airflow 79 around the filter element 41 may provide a more even distribution of airflow into the filter element 41. The dimensions and geometry of the flow directing portion 73 may vary with application. For example, the flow directing portion 73 may include an angled wedge shaped form, as depicted in FIG. 10. As one alternative, the flow directing portion 73 may include one half of a tapered conical shaped form (not depicted).

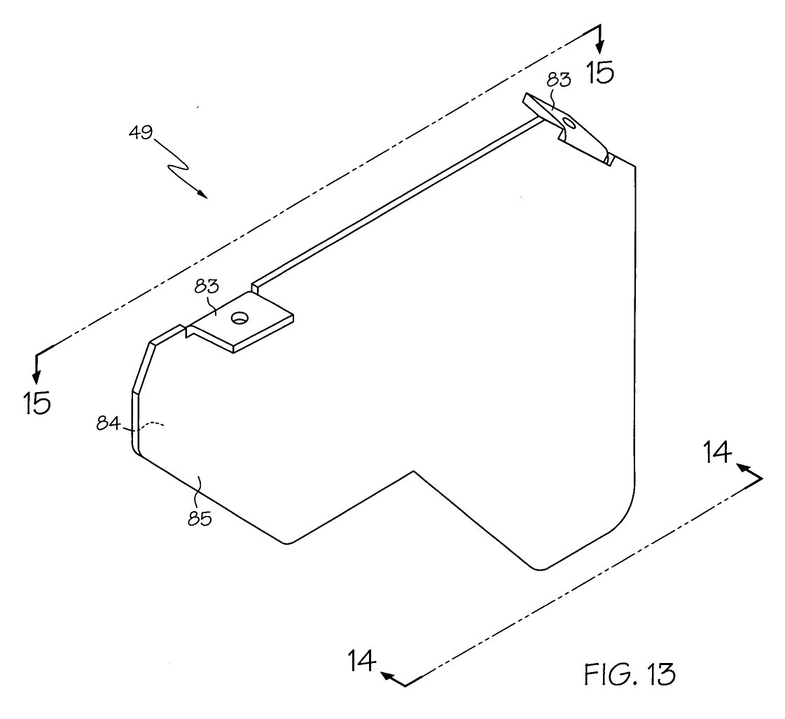

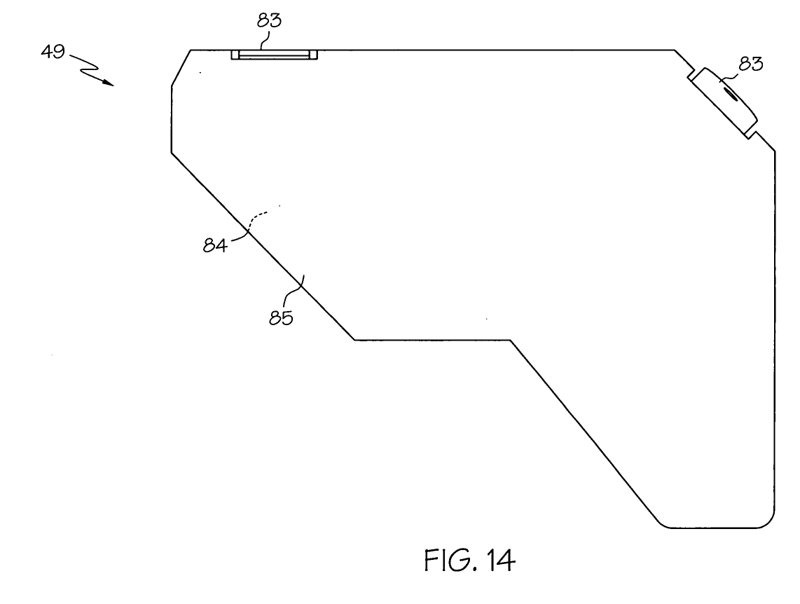

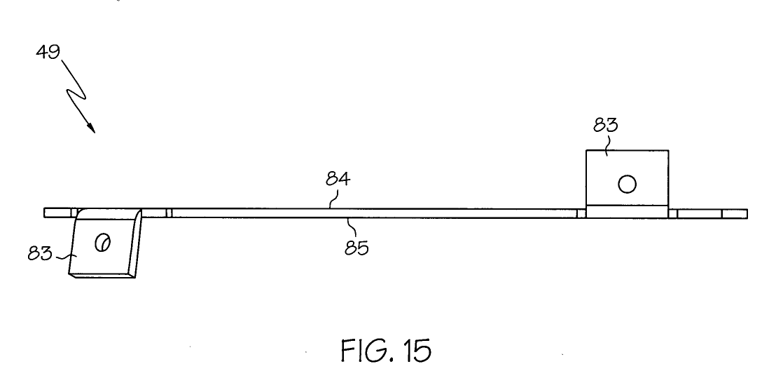

An embodiment of the diverter member 49 is depicted in FIGS. 13-15. The diverter member 49 may be attached to the bottom side 69 of the cover member 48 and extend downward. The diverter member 49 may be attached about perpendicular to the cover member 48, forming a diverter angle 88 of about 90°, as depicted in FIG. 4a. The diverter angle 88 may be the angle formed by a line 89a through the diverter member 49 and a line 89b through the cover member 48, as depicted in FIG. 4a. The diverter angle 88 may vary with application may depend on factors including the velocity of the duct airflow 79 and the shape of the filter element 41. For some applications, the diverter angle 88 may be between about 5° and about 90°. In an alternate embodiment (not shown), the diverter member 49 may be attached to the housing 42 and extend upward. The diverter member 49 may be integral to the cover member 48 (or housing 42). The diverter member 49 may be attached (e.g. welded or bolted) to the cover member 48 (or housing 42).

The shape and dimensions of the diverter member 49 may vary and may depend on factors including the dimensions of the filter element 41, the dimensions of the housing 42, the dimensions of the duct 77, and the application. For some applications, the diverter member 49 may comprise a flat shaped structure. In an alternate embodiment (not shown), the diverter member 49 may comprise a curved plate member. The diverter member 49 may comprise a first side 84, a second side 85, and one or more fastener tabs 83, as depicted in FIG. 13. The first side 84 may be the side towards the duct 77 and the second side 85 may be the side towards the filter element 41.

The diverter member 49 may be positioned at a distance 87 from the filter element 41, as depicted in FIG. 4a. The distance 87 may allow the duct airflow 79 to pass between the filter element 41 and the diverter member 49. The distance 87 may vary with application. For example, the distance 87 may be about 1.0 inches for a BMW M3 application. For some applications, the distance 87 may be between about 0.5 inches and about 2.0 inches.

The diverter member 49 may be positioned between the filter element 41 and the duct 77. The diverter member 49 may extend into the path of the duct airflow 79, as depicted in FIG. 4a. During operation, the duct airflow 79 may contact the diverter member 49. By obstructing the duct airflow 79, the diverter member 49 may slow the velocity of the duct airflow 79 and alter its path. The diverter member 49 may prevent the duct airflow 79 from contacting the filter element 41 “straight on”, which may avoid a rush of airflow into the engine 70, which may potentially stall the engine. By altering the path of the duct airflow 79, the diverter member 49 may cause the duct airflow 49 to be more evenly distributed around the circumference of the filter element 41, which may increase filter life and efficiency. The diverter member 49 may comprise various materials including powder-coated steel, aluminum, plastic, and others.

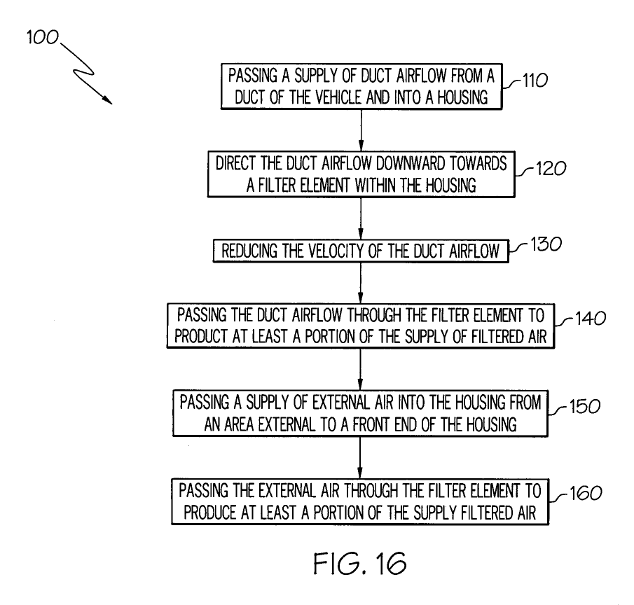

A method 100 of providing a supply of filtered air to a vehicle engine is depicted in FIG. 16. The method 100 may comprise a step 110 of passing a supply of duct airflow 79 from a duct 77 of the vehicle 75 and into a housing 42; a step 120 of directing the duct airflow 79 downward towards a filter element 41 within the housing 42; a step 130 of reducing the velocity of the duct airflow 79; and a step 140 of passing the duct airflow 79 through the filter element 41 to produce at least a portion of the supply of filtered air.

The method 100 further may comprise a step 150 of passing a supply of external air 78 into the housing 42 from an area external to a front end of the housing 42 and a step 160 of passing the external air 78 through the filter element 41 to produce at least a portion of the supply of filtered air.

The step 110 of passing a supply of duct airflow 79 may comprise passing the duct airflow 79 such that the duct airflow 79 passes between a cover assembly 45 and the housing 42. The step 120 of directing the duct airflow 79 may comprising passing the duct airflow 79 along a flow directing portion 73 of the cover assembly 45. The step 130 of reducing the velocity of the duct airflow 79 may comprise passing the duct airflow 79 such that the duct airflow 79 contacts a diverter member 49 of the cover assembly 45. The step 140 may comprise passing the duct airflow 79 through the pleated filter material of an inverted-top cone filter (e.g., filter element 41). The step 150, of passing a supply of external air 78 may comprise passing the external air 78 between the housing 42 and a lip 72 of the cover assembly 45. The step 160 may comprise passing the external air 78 through the pleated filter material of an inverted-top cone filter (e.g., filter element 41).

As can be appreciated by those skilled in the art, embodiments of the present invention provide improved high flow air filtration systems. The filtration systems according to embodiments of the present invention can reduce airflow velocity through the filter, thereby reducing engine stalls due to rush on air into the engine. Embodiments of the provided filtration systems can more evenly distribute the airflow around the circumference of the filter, improving filter efficiency. Embodiments of the present invention can include an integrated mass airflow sensor pad, which may ease system installation.

It should be understood, of course, that the foregoing relates to exemplary embodiments of the invention and that modifications may be made without departing from the spirit and scope of the invention as set forth in the following claims.

We claim:

1. A system for an engine comprising:
a housing having a filter cavity;
a filter element positioned within said filter cavity;
a cover member removably attached to said housing; and
a diverter member positioned between said filter element and a duct of said engine.

2. The system of claim 1, wherein said diverter member extends downward from said cover member.

3. The system of claim 1, wherein said cover member includes a lip positioned along an edge of said cover member.

4. The system of claim 1, wherein said cover member includes a flow directing portion adapted to direct a flow from said duct downward and toward said filter element.

5. The system of claim 1, further comprising an adapter positioned such that an upstream end of said adapter is coupled to a back end of said filter element; and a mass airflow sensor pad operationally connected to said adapter.

6. The system of claim 5, wherein an inner diameter of said adapter towards said upstream end is greater than an inner diameter of said adapter towards a downstream end.

7. The system of claim 6, wherein said adapter includes at least one angle for reducing said inner diameter.

8. The system of claim 1, wherein an edge of said cover member is designed to follow the profile of said duct.

9. The system of claim 1, wherein said diverter member is attached to said housing.

10. The system of claim 1, wherein a distance between said filter element and said diverter member is between about 0.5 inches and about 2.0 inches.

11. A system for an engine comprising:
a housing;
an inverted-top cone filter positioned within said housing;
an adapter clamped to a back end of said inverted-top cone filter; and
a cover assembly removably attached to said housing.

12. The system of claim 11, wherein said cover assembly comprises a cover member and a diverter member extending downward from said cover member.

13. The system of claim 12, wherein said diverter member is integral to said cover member.

14. The system of claim 12, wherein said diverter member is positioned between said inverted-top cone filter and a duct of said engine.

15. The system of claim 11, wherein said housing includes at least one hole for bolting said housing to said adapter.

16. The system of claim 11, further comprising a mass airflow sensor pad operationally connected to said adapter.

17. The system of claim 16, wherein said mass airflow sensor pad is welded to said adapter.

18. The system of claim 11, wherein said adapter comprises a metal.

19. A system for a vehicle comprising:
a housing bolted to a chassis of said vehicle;
a filter element positioned within a filter cavity of said housing;
an adapter clamped to said filter element;
a cover member in contact with said housing, said cover member having an upwardly bent edge; and
a diverter member extending from said cover member and into said filter cavity.

20. The system of claim 19, wherein said adapter is coupled to a plenum box tube of said vehicle.

21. The system of claim 19, wherein cover member includes a flow directing portion.

22. The system of claim 19, wherein said diverter member and said cover member form a diverter angle between about 5° and about 90°.

23. An assembly for a filtration system comprising:
a housing;
a cover member removably attached to said housing; and
a diverter member extending downward from said cover member.

24. The assembly of claim 23, wherein said cover member includes a lip extending upward along an edge of said cover member, said lip adapted to direct a supply of external air into said housing.

25. The assembly of claim 23, wherein said cover member includes a flow directing portion.

26. The assembly of claim 25, wherein said flow directing portion is positioned over a filter element of said filtration system, said flow directing portion adapted to direct a supply of duct airflow downward and toward said filter element.

27. A system for a vehicle comprising:
a powder-coated steel housing bolted to a chassis of said vehicle;
an inverted-top cone filter positioned within a filter cavity of said powder-coated steel housing;
an aluminum adapter having an inlet opening at an upstream end and an outlet opening towards a downstream end, said aluminum adapter including a flow path extending from said inlet opening to said outlet opening, said aluminum adapter clamped to said inverted-top cone filter, said aluminum adapter including at least one angle such that an inner diameter towards said upstream end is greater than an inner diameter towards said downstream end;
a mass airflow sensor pad operationally connected to said aluminum adapter;
a cover member removably attached to said powder-coated steel housing, said cover member having an upwarding extending lip and a flow directing portion; and
a diverter member connected to said cover member, said diverter member extending downward into said filter cavity, said diverter member positioned between said inverted-top cone filter and a duct of said vehicle.

28. A method of providing a supply of filtered air to a vehicle engine comprising the steps of:
passing a supply of duct airflow from a duct of said vehicle and into a housing;
directing said duct airflow downward towards a filter element within said housing;
reducing the velocity of said duct airflow; and
passing said duct airflow through said filter element to produce said supply of filtered air.

29. The method of claim 28, wherein said step of directing said duct airflow comprises passing said duct airflow along a flow directing portion of a cover assembly, said cover assembly removably attached to said housing.

30. The method of claim 28, wherein said step of reducing the velocity of said duct airflow comprises passing said duct airflow such that said duct airflow contacts a diverter member of a cover assembly, said cover assembly removably attached to said housing.

31. The method of claim 28, wherein said step of passing a supply of duct airflow from a duct comprises passing said duct airflow such that said duct airflow passes between a cover assembly and said housing.

33. The method of claim 29, further comprising the steps of:
passing a supply of external air into said housing from an area external to a front end of said housing; and
passing said external air through said filter element to produce at least a portion of said supply of filtered air.

34. The method of claim 33, wherein said passing a supply of external air may comprise passing said external air between said housing and a lip of a cover assembly, said cover assembly removably attached to said housing.
